(19) United States
(12) Patent Application Publication
(10) Pub. No.: US 2006/0170199 A1
(43) Pub. Date: Aug. 3, 2006

(54) BELT GUIDE APPARATUS FOR A SEATBELT RESTRAINT SYSTEM OF A VEHICLE

(76) Inventors: Srinivasan Sundararajan, Ann Arbor, MI (US); Sundeep V. Kankanala, Ann Arbor, MI (US); Dean Jaradi, Macomb, MI (US); Said Nakhla, Clarkston, MI (US); Marius Magdun, Cicero, IN (US); Mike Heidom, Scottsdale, AZ (US); Wesley D. Pack, Gilbert, AZ (US); Robert V. McClenathan, Wixom, MI (US)

Correspondence Address: ARTZ & ARTZ, P.C., 28333 TELEGRAPH ROAD, SUITE 250, SOUTHFIELD, MI, 48034, US

(21) Appl. No.: 10/906,078

(22) Filed: Feb. 2, 2005

(51) Int. Cl. B60R 21/18; B60R 22/00

(52) U.S. Cl. 280/733; 280/808

(57) ABSTRACT

One embodiment of the present invention is a belt guide apparatus (14) for an enhanced seatbelt restraint system (10) for a vehicle. The belt guide apparatus (14) includes a pivotal fastener (56) for attaching the belt guide apparatus (14) to a vehicle structure (20). The pivotal fastener (56) includes an interface portion (42) extending therefrom for supporting a belt (12) extending through the belt guide apparatus (14). Also, the pivotal fastener (56) is utilized for moving the belt guide apparatus (14) in three or more directions for maintaining the belt (12) substantially flat against the interface portion (42). Moreover, the interface portion (42) has a biasing mechanism (64) disposed adjacent thereto for pressing the belt (12) substantially flat against the interface portion (42).

### TECHNICAL FIELD

The present invention relates generally to vehicles, and more particularly to a belt guide apparatus for a seatbelt restraint system of a vehicle.

### BACKGROUND

Automotive manufacturers are well known for continuously improving seatbelt restraint systems of vehicles. Specifically, seatbelt restraint systems have been developed including mechanical pretensioners, electrical pretensioners, and/or pyrotechnic pretensioners, which are utilized for locking or tightening the seatbelt with predetermined loads during a crash event. One skilled in the art will appreciate that these mechanisms have substantially increased the safety of vehicle occupants.

It would therefore be desirable to provide an enhanced seatbelt restraint system for further improving the safety of vehicle occupants.

### SUMMARY OF THE INVENTION

One embodiment of the present invention is a belt guide apparatus for a vehicle seatbelt restraint system. The belt guide apparatus includes a pivotal fastener for attaching the belt guide apparatus to a vehicle structure. The pivotal fastener includes an interface portion extending therefrom for supporting a belt. Also, the pivotal fastener is utilized for moving the belt guide apparatus in three or more directions for maintaining the belt substantially flat against the interface portion. Moreover, the interface portion has a biasing mechanism disposed adjacent thereto for pressing the belt substantially flat against the interface portion.

One advantage of the present invention is that a belt guide apparatus for an enhanced seatbelt restraint system is provided that minimizes edge loading of a belt during a vehicle collision.

Another advantage of the present invention is that a belt guide apparatus for an enhanced seatbelt restraint system is provided that has a robust construction for withstanding substantially high loads.

Yet another advantage of the present invention is that a belt guide apparatus for an enhanced seatbelt restraint system is provided that substantially improves the safety of vehicle occupants.

Other advantages of the present invention will become apparent upon considering the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of the examples of the invention:

FIG. 1A is a schematic view of an enhanced seatbelt restraint system having an inflatable seatbelt in an undeployed configuration, according to one advantageous embodiment of the claimed invention.

FIG. 1B is a schematic view of the enhanced seatbelt restraint system shown in FIG. 1B, illustrating the inflatable seatbelt in a deployed configuration.

FIG. 2A is a cross-sectional view of the inflatable seatbelt shown in FIG. 1A, as taken along line 2A-2A.

FIG. 2B is a cross-sectional view of the inflatable seatbelt shown in FIG. 1B, as taken along line 2B-2B.

FIG. 3 is an enlarged perspective view of a belt guide apparatus of the enhanced seatbelt restraint system shown in FIG. 1A, illustrating the belt guide apparatus supporting the undeployed inflatable belt.

FIG. 4A is a partially cutaway plan view of the belt guide apparatus shown in FIG. 3, illustrating the belt guide apparatus in a belt-flattening configuration for supporting the undeployed inflatable belt.

FIG. 4B is a partially cutaway plan view of the belt guide apparatus shown in FIG. 4A, illustrating the belt guide apparatus in an offset configuration for supporting a deployed inflatable belt.

FIG. 5A is a partially cutaway plan view of the belt guide apparatus shown in FIG. 4A, according to another advantageous embodiment of the claimed invention.

FIG. 5B is a partially cutaway plan view of the belt guide apparatus shown in FIG. 4B, according to another advantageous embodiment of the claimed invention.

### DETAILED DESCRIPTION OF THE INVENTION

In the following figures, the same reference numerals are used to identify the same components in the various views.

The present invention is particularly suited for an inflatable seatbelt restraint system that is integrated within an automotive vehicle. Specifically, the described embodiments detail a belt guide apparatus for supporting an inflatable shoulder belt portion of the inflatable seatbelt restraint system. In this way, the embodiments described herein employ structural features where the context permits. However, various other embodiments are contemplated having different combinations of the described features, having features other than those described herein, or lacking one or more of those features. For example, the invention may instead utilize conventional seatbelt webbing for the shoulder belt portion, the lap belt portion, or any combination thereof. By way of another example, the belt guide apparatus can also be utilized for supporting a lap belt portion of the inflatable seatbelt as desired. For that reason, it is contemplated that the invention can be carried out in a variety of other modes and utilized for other suitable applications as desired.

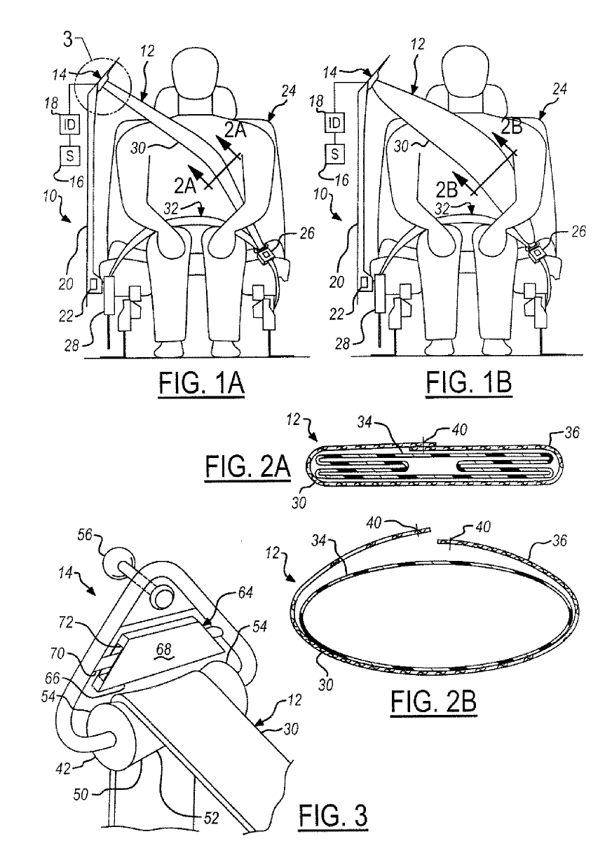

Referring to FIGS. 1A and 1B, there are shown schematic views of an enhanced seatbelt restraint system 10 (“seatbelt system”) having an inflatable seatbelt 12 and a belt guide apparatus 14 for supporting the inflatable seatbelt 12, according to one advantageous embodiment of the claimed invention. Specifically, FIG. 1A shows the enhanced seatbelt restraint system 10 in an undeployed configuration while FIG. 1B shows the enhanced seatbelt restraint system 10 in a deployed configuration.

The enhanced seatbelt restraint system 10 includes one or more sensors 16 for detecting a vehicle collision event. These sensors 16 can be various suitable accelerometers known in the art. Moreover, these sensors 16 are coupled to the inflator device 18, which is coupled to the inflatable seatbelt 12. In this way, the sensors 16 are utilized for actuating the inflator device 18 and inflating the inflatable seatbelt 12.

In this embodiment, the inflator device 18 is integrated within a vehicle pillar 20 adjacent to a shoulder belt retractor 22. However, it will be appreciated that the inflator device 18 can instead be secured to a vehicle seat assembly 24 adjacent to lap belt buckle 26, the outboard belt anchor 28, or a variety of other suitable vehicle structures as desired.

Also in this embodiment, the inflatable seatbelt 12 is comprised of a shoulder belt portion 30 with an airbag module 34 (shown in FIG. 2A) enclosed therein and a lap belt portion 32 that is compromised of conventional seatbelt webbing. However, it is contemplated that the shoulder belt portion 30, the lap belt portion 32, or any combination thereof can have the airbag module 34 as desired. Likewise, it is contemplated that the entire seatbelt can be comprised of conventional webbing as desired.

Referring now to FIGS. 2A and 2B, there are respectively shown cross-sectional views of the shoulder belt portion 30 shown in FIGS. 1A and 1B, as taken along line 2A-2A and line 2B-2B. This shoulder belt portion 30 is comprised of one panel 36 of conventional seatbelt webbing and a folded airbag module 34 enclosed within the panel 36. One or more rip seams 40 secure the panel 36 together and are torn when the inflator device 18 inflates the airbag module 34. However, it is contemplated that the inflatable seatbelt 12 can have more than one panel 36 or various other suitable constructions as desired.

With attention to FIG. 3, there is shown an enlarged perspective view of the belt guide apparatus 14, illustrated in FIG. 1A as taken within circle 3. The belt guide apparatus 14 has a ring construction for supporting and passing the inflatable seatbelt 12 therethrough. This ring construction preferably has one or more generally flat interface portions 42 for distributing a load substantially across the width of the inflatable seatbelt 12. In other words, the ring construction is sized and shaped for providing substantially even support across the inflatable seatbelt 12 and minimizing the concentration of a load in one or more discrete sections of the inflatable seatbelt 12. In this way, the inflatable seatbelt 12 can withstand a substantially high load.

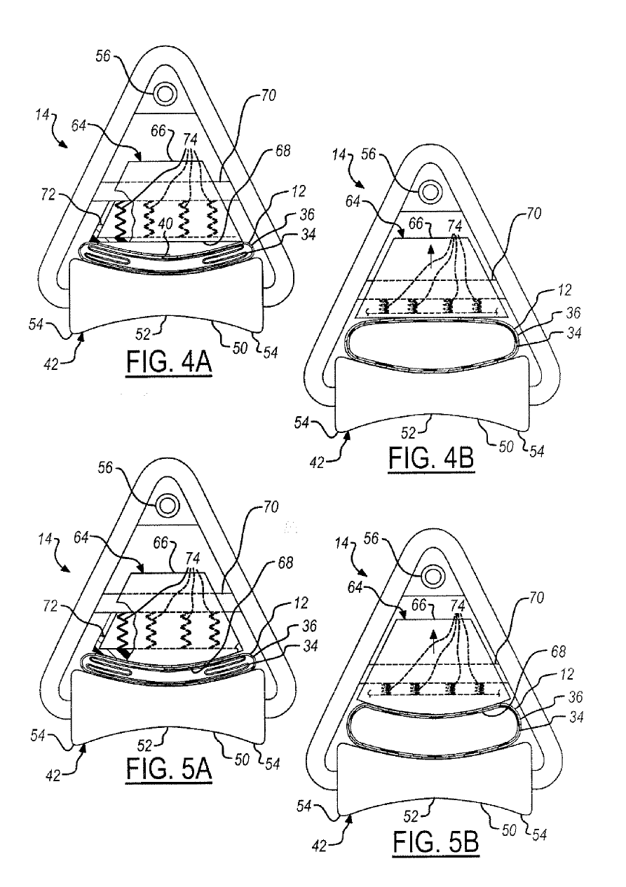

In this example, as detailed in the descriptions for FIGS. 4A-5B, the ring construction is generally triangular with the interface portion 42 being a roller member rotatably coupled to the ring construction. However, it is contemplated that the ring construction can have a variety of other suitable shapes, even ones without a generally flat interface portion and/or a roller member.

In addition, it will also be appreciated that the flat interface portion 42 assists in preventing the inflatable seatbelt 12 from bunching together or otherwise folding over itself as the shoulder belt retractor 22 winds the inflatable seatbelt 12. In this regard, the belt guide apparatus 14 minimizes the risk of inflatable seatbelt 12 from becoming tangled around the shoulder belt retractor 22 and inadvertently locking or otherwise impeding the retractor 22 from retracting and/or releasing the inflatable belt 12.

Furthermore, this feature is beneficial for laying the shoulder belt portion 30 of the inflatable seatbelt 12 substantially flat across the chest of a vehicle occupant. In this way, the belt guide apparatus 14 enhances the comfort of the vehicle occupant. One skilled in the art will also appreciate that the belt guide apparatus 14 can instead be utilized for laying the lap belt portion 32 substantially flat across the lap of a vehicle occupant as desired.

In the embodiments shown in FIGS. 4A-5B and introduced hereinabove, the interface portion 42 is a roller member that is rotatably coupled to the ring construction of the belt guide apparatus 14. This roller member has a generally concave supporting surface 50 for maintaining the inflatable seatbelt 12 substantially flat on the roller member. In other words, the roller member has a center portion 52 and opposing end portions 54 being thicker than the center portion 52. For this reason, the seatbelt 12 does not move laterally across the roller member and fold or otherwise bunch up against one side of the ring construction. It is contemplated that the supporting surface 50 can have various other suitable contours, e.g. a convex contour, for maintaining the seatbelt 12 on the interface portion 42.

Also, in this embodiment, the ring construction of the belt guide apparatus 14 has a pivotal fastener 56 extending therefrom for mounting the belt guide apparatus 14 to a vehicle pillar 20 (shown in FIGS. 1A and 1B). Specifically, the pivotal fastener 56 is utilized for moving the belt guide apparatus 14 in the direction of the seatbelt loading. In this way, the belt 12 remains substantially flat against the belt guide apparatus 14 and provides the various advantages described hereinabove.

Specifically, in this embodiment, the pivotal fastener 56 is a substantially spherical protrusion and is utilized for being housed within a socket (not shown) formed in the vehicle pillar 20. However, it will be appreciated that the pivotal fastener 56 can be various other suitable fasteners as desired. For instance, the socket can instead be formed within the belt guide apparatus 14 for receiving a substantially spherical protrusion extending from the vehicle pillar 20. In addition, as introduced hereinabove, it is contemplated that the belt guide apparatus 14 can be attached to the lap belt buckle 26, the outboard belt anchor 28, or various other suitable vehicle structures.

The belt guide apparatus 14 further includes a biasing mechanism 64 for selectively forcing the inflatable seatbelt 12 substantially flat against the interface portion 42. FIG. 4A shows the biasing mechanism 64 in a belt-flattening configuration with the undeployed inflatable belt 12 sandwiched between a belt-adjusting surface 66 of the biasing mechanism 64 and the supporting surface 50 of the interface portion 42. FIG. 4B shows the biasing mechanism 64 moved to an offset configuration by the deployed inflatable seatbelt 12.

In this embodiment, the biasing mechanism includes a housing 68, which is slidably coupled to a cross member 70 of the ring construction. This housing 68 has a channel 72 formed therethrough which is sized for receiving the cross member 70 and moving the housing 68 between the belt-flattening configuration and the offset configuration.

The biasing mechanism 64 further includes one or more springs 74 or other suitable resilient members for forcing the biasing mechanism 64 to the belt-flattening configuration. Specifically, these springs 74 are coupled between the cross member 70 and the supporting surface 50 of the housing 68. However, it is contemplated that the biasing mechanism 64 can have various other suitable constructions with resilient members for forcing the biasing mechanism 64 to the belt-flattening configuration. In addition, it will be appreciated that the biasing mechanism 64 can be comprised of an elastic material for deforming to a variety of shapes, e.g. concave, as the airbag 34 is inflated.

Moreover, the springs 74 are sufficiently stiff for pressing the inflatable seatbelt 12 substantially flat against the interface portion 42 while allowing the inflating airbag 34 to force the biasing mechanism 64 to the offset configuration.

In another embodiment shown in FIGS. 5A and 5B, the biasing mechanism 64 has a generally downwardly curved belt-adjusting surface 66. In this regard, a substantial portion of the biasing mechanism 64 contacts the seatbelt 12 as desired.

While particular embodiments of the invention have been shown and described, it will be understood, of course, that the invention is not limited thereto since modifications may be made by those skilled in the art, particularly in light of the foregoing teachings. Accordingly, it is intended that the invention be limited only in terms of the appended claims.

What is claimed is:

1. A belt guide member for an enhanced seatbelt restraint system of a vehicle, comprising:
a pivotal fastener for attachment to a vehicle structure;
an interface portion extending from said pivotal fastener for supporting a belt extending through the belt guide member; and
a biasing mechanism disposed adjacent to said interface portion for pressing said belt substantially flat against said interface portion;
wherein said pivotal fastener moves the belt guide member in at least three directions for maintaining said belt substantially flat against said interface portion.

2. The belt guide member recited in claim 1 wherein said pivotal fastener and said vehicle structure comprise a ball-and-socket coupling for moving the belt guide member in said at least three directions.

3. The belt guide member recited in claim 1 wherein said interface portion has a supporting surface that is contoured for biasing said belt toward a center portion of said interface portion.

4. The belt guide member recited in claim 3 wherein said interface portion has opposing end portions that are thicker than said center portion of said interface portion.

5. The belt guide member recited in claim 1 further comprising:
a ring construction with a cross member integrated therein for mounting said biasing mechanism thereto.

6. The belt guide member recited in claim 5 wherein said biasing mechanism includes a housing coupled to said cross member and at least one resilient member coupled between said housing and said cross member for forcing said housing onto said belt and maintaining said belt substantially flat against said interface portion.

7. The belt guide member recited in claim 6 wherein said housing has a channel formed therethrough for receiving said cross member.

8. The belt guide member recited in claim 7 wherein said channel is sized for moving said biasing mechanism between a belt-flattening configuration and an offset configuration.

9. The belt guide member recited in claim 6 wherein said housing has a belt-adjusting surface contoured for substantially flattening said belt against a supporting surface of said interface portion of said belt member guide.

10. The belt guide member recited in claim 9 wherein said supporting surface is sized for substantially receiving said belt-adjusting surface.

11. A belt guide member for an enhanced seatbelt restraint system of a vehicle, comprising:
a ring construction with a cross member integrated therein;
a pivotal fastener integrated in said ring construction for attaching the belt guide member to a vehicle structure;
an interface portion being a roller member that is rotatably coupled to said ring construction, said roller member utilized for supporting a belt extending through the belt guide member; and
a biasing mechanism disposed adjacent to said cross member for pressing said belt substantially flat against said interface portion;
wherein said pivotal fastener moves the belt guide member in at least three directions for maintaining said belt substantially flat against said interface portion.

12. The belt guide member recited in claim 11 wherein said pivotal fastener and said vehicle structure comprise a ball-and-socket coupling for moving the belt guide member in said at least three directions.

13. The belt guide member recited in claim 11 wherein said roller member has a supporting surface that is contoured for biasing said belt toward a center portion of said roller member.

14. The belt guide member recited in claim 13 wherein said roller member has opposing end portions that are thicker than said center portion of said roller member.

15. The belt guide member recited in claim 11 wherein said biasing mechanism includes a housing coupled to said cross member and at least one resilient member coupled between said housing and said cross member for forcing said housing onto said belt and maintaining said belt substantially flat against a supporting surface of said roller member.

16. The belt guide member recited in claim 15 wherein said housing has a channel formed therethrough for receiving said cross member.

17. The belt guide member recited in claim 15 wherein said housing has a belt adjusting surface contoured for substantially flattening said belt against a supporting surface of said roller member of said belt member guide.

18. The belt guide member recited in claim 17 wherein said supporting surface of said roller member is sized for substantially receiving said belt-adjusting surface of said biasing mechanism.

19. An enhanced seatbelt restraint system for a vehicle, comprising:
an inflatable belt;
an inflator device coupled to said inflatable belt;
at least one crash sensor coupled to said inflator device for actuating said inflator device to inflate said inflatable belt;
a belt guide member pivotally coupled to a vehicle structure, said belt guide member utilized for supporting said inflatable belt and minimizing an edge loading on said inflatable belt;
wherein said belt guide member includes a pivotal fastener for attachment to said vehicle structure;
wherein said belt guide member further includes an interface portion extending from said pivotal fastener for supporting said inflatable belt extending through said belt guide member; and
wherein said belt guide member further includes a biasing mechanism that is movable between a belt-flattening configuration and an offset configuration;
wherein said biasing member in said belt-flattening configuration presses said inflatable belt substantially flat against said roller member;
wherein said biasing member in said offset configuration is offset a predetermined distance from said roller member for providing room for said inflatable belt to inflate;
wherein said pivotal fastener moves the belt guide member in at least three directions for maintaining said belt substantially flat against said interface portion.

20. The enhanced seatbelt restraint system recited in claim 19 wherein inflatable belt is comprised of at least one of an inflatable shoulder belt portion and an inflatable lap belt portion.
